(19) United States
(12) Patent Application Publication
(10) Pub. No.: US 2007/0268914 A1
(43) Pub. Date: Nov. 22, 2007

(54) Tenant network controller apparatus and method

(75) Inventors: Eric Fisher, Bloomington, IL (US); Darren Rogers, Bloomington, IL (US); Mike Kesler, Normal, IL (US); Rob Judd, Waynesville, IL (US)

Correspondence Address: HUSCH & EPPENBERGER, LLC, 190 CARONDELET PLAZA, SUITE 600, ST. LOUIS, MO, 63105-3441, US

(73) Assignee: BROADOPS, LLC, Normal, IL (US)

(21) Appl. No.: 11/656,749

(22) Filed: Jan. 22, 2007

Related U.S. Application Data
(60) Provisional application No. 60/774,059, filed on Feb. 16, 2006.

(51) Int. Cl. H04L 12/28

(52) U.S. Cl. 370/400

(57) ABSTRACT

A tenant LAN controller includes an association of an MAC address with a geographic location in a first memory; a router connecting a WAN to a plurality of individual computers and a processor. The processor is configured to turn off an individual computer's internet access upon the individual computer being associated with a triggering event, where the individual computer is identified by the association of a geographic location with an MAC address in the first memory. The processor is further configured to throttle bandwidth according to instructions received via said WAN from a web page and is further configured to send messages to a particular MAC address according to the association of geographic locations with the MAC addresses; and is configured to log acknowledgements. The acknowledgements are stored in a second memory, and are associated in the second memory with a MAC address.

### CROSS-REFERENCE TO RELATED APPLICATIONS

This application claims priority from U.S. Provisional Patent Application No. 60/774,059 filed Feb. 16, 2006.

### BACKGROUND OF THE INVENTION

1. Field of the Invention

The present invention is in the field of local area network (LAN) control, particularly as applied to multi-dwelling units (MDUs).

2. Related Art

Some studies indicate that as many as half the people in the United States live in rental housing. Of course the vast majority of these live in apartment buildings. In recent years it has become commonplace for a property manager or landlord to offer internet access with rental of an apartment as part of a package of combined services obtained in exchange for rent. Providing internet service creates new responsibilities for a property manager and, in some respects, also new opportunities.

Physical installation of the internet in apartment buildings typically comprises a single router for an apartment building or complex of apartments. This router is assigned a public IP address. A plurality of individual computers is linked to the router, thereby comprising a LAN. Each individual computer in the LAN has a media access control (MAC) address.

Delinquent rent has long been a problem for property managers. Desirable services associated with rent present a potential motivator for timely payment of rent. Accordingly, there is a need in the art for a system that will turn off a service such as internet access to an individual tenant for delinquent rent.

A more recent responsibility for property managers is ensuring adequate speed of internet access for all tenants. This can become problematic when a single tenant is pursuing activities that occupy a disproportionate amount of bandwidth and concomitantly slow internet connections for that user's neighbors. Accordingly, there is a need for a bandwidth control system for property managers responsible for MDUs. More particularly, there is a need in the art for bandwidth management controllable in real time by a third party such as a property manager from a remote location. There is a need for either or both of bandwidth control via a website and/or via an application specific interface with property management software applications.

Another recurring expense for property managers and landlords are the necessary periodic notices to tenants. These notices include things like notification of maintenance of facilities, for example, paving a parking lot. Such notices may further be individually directed, such as to an individual who is delinquent on his rent, or is overusing his internet access or who is being victimized by a virus that in turn is threatening other users on the LAN. Previously such notices by hard copy to individual apartments are known to cost from $500 to $1,000 for a notice to all the tenants in a complex. There is a need in the art for access to individual MAC addresses by a third party not providing the internet access or service, and in particular by a property manager through a website or property management application software interface.

Another recurring problem for property managers and landlords is a denial of notice by tenants. Accordingly, there is a need in the art for a database storing a history of acknowledgements by a tenant thereby recording proof that a particular notice was received. There is a further need in the art for management of such acknowledgement histories via a web page or property management software application interface.

The desirability of distributing internet advertising according to precisely focused geographic information is well established. See for example, U.S. Patent Application No. 2005/0187823 A1 by Howes or Application No. 2005/0050097 A1 by Yeh et al. However, current systems are capable only of resolving a particular geographic location as narrowly as a zip code or a direct marketing area (DMA). Third parties, such as Internet Service Providers (ISPs), solicitors, law enforcement, and the like are typically capable of obtaining information about an individual human user at the level of a public IP address. Some third parties maintain some data on users, such as websites visited or pages viewed, but do not correlate that data with geographical data.

There is a need in the art for a more finely grained and precise method of directing internet messaging, particularly advertising, in general, and particularly by entities who are not themselves providing internet access or services to a user.

There is a need in the art for messaging such as advertising to individual users by MAC address via an association of the MAC address with a real world geographic location, i.e., a street address. There is a need for a system for correlating third party data on individual internet use with a database of geographical data.

### SUMMARY OF THE INVENTION

A tenant LAN controller includes an association of an MAC address with a geographic location in a first memory; a router connecting a WAN to a plurality of individual computers and a processor. The processor is configured to turn off an individual computer's internet access upon the individual computer being associated with a triggering event, where the individual computer is identified by the association of a geographic location with an MAC address in the first memory. The processor is further configured to throttle bandwidth according to instructions received via said WAN from a web page and is further configured to send messages to a particular MAC address according to the association of geographic locations with the MAC addresses; and is configured to log acknowledgements. The acknowledgements are stored in a second memory, and are associated in the second memory with a MAC address.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an MDU LAN.

FIG. 2 is a block diagram of an MDU LAN as controlled by the present invention.

FIG. 3 is a flow chart of real world user turn off command process.

FIG. 4 is a block diagram of usage control elements of the MDU LAN controller.

FIG. 5 is a flowchart depicting steps for access shutoff for a policy violation.

FIG. 6 is a flowchart depicting the steps of access shutoff for virus detection.

FIG. 7 is a flowchart depicting advertising placement in an MDU environment.

FIG. 8 is a flowchart depicting the steps for advertising placement at a network level.

FIG. 9 is a flowchart depicting the steps for message targeting by integration of multiple databases.

FIG. 10 is a display of the web server page for a property manager.

FIG. 11 is a depiction of usage control fields on a property manager's web page.

FIG. 12 depicts a message entry field in a property manager's web server.

FIG. 13 is a flowchart depicting the steps for initializing messages.

### DETAILED DESCRIPTION OF THE PREFERRED EMBODIMENTS

The following description of the preferred embodiment(s) is merely exemplary in nature and is in no way intended to limit the invention, its application, or uses.

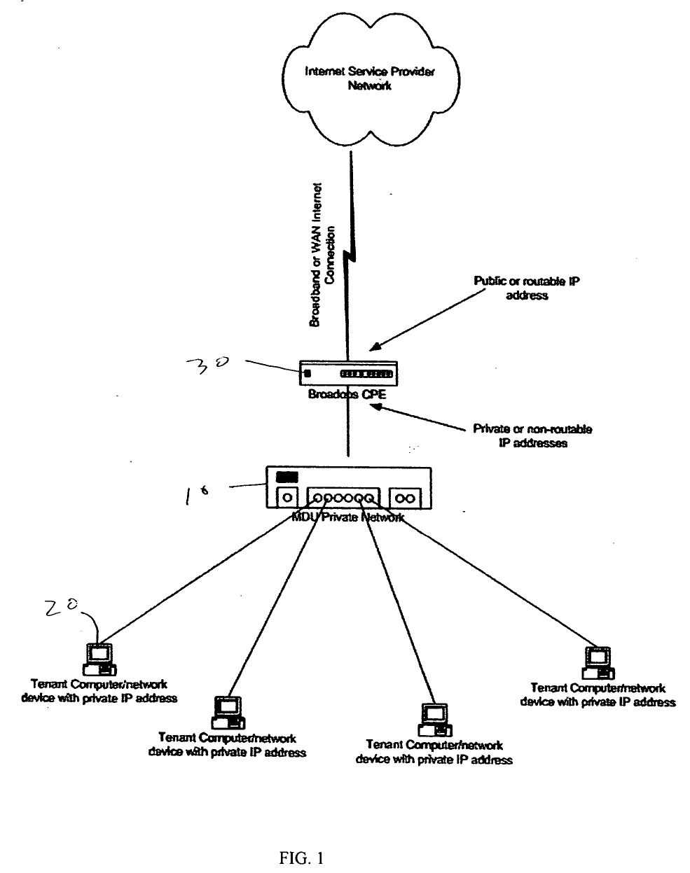

Referring now to the drawings wherein like reference numbers indicate like elements, FIG. 1 is a block diagram of an MDU LAN. The MDU LAN server 10 has multiple hard wire ports in order to allow access by a plurality of individual computers 20 and their users. Each individual computer will have a private IP address and a MAC address. The connection between each individual computer 20 and the MDU LAN server 10 may be by any means, including without limitation, hard wire, telephone line, cable, fiber optic or radio frequency transmission (“WIFI”). The MDU LAN server 10 is in operative communication with the broader computer network through a router 30. In the embodiments depicted throughout this application, the broader computer network is depicted as the internet, although other wide area networks (WANs) may be the computer network through which the present invention may operate without departing from the scope of the present invention.

In the prior art, router 30 was any of a plurality of conventional routers known to the art. In the embodiment depicted in FIG. 1, router 30 is comprised of customer premises equipment (CPE) of the present invention which is configured to execute router functions, among other functions. In both the prior art and the present invention, internet service providers (ISPs) on the internet or other inquiring entities have accessible to them only a public IP address which is available to those entities through the internet from the router 30. Distal to the router/CPE 30 private or non-routable IP addresses (MAC addresses) of individual users and their individual computers 20 are identified and used for routing traffic. MAC addresses are associated with Ethernet networks, whether hardwired or wireless. It should be understood that as the term “MAC address” is used in this patent application, a unique network identifier that is unique to each individual computer 20 is meant. Some non-Ethernet networks do not use MAC addresses per se for their unique network identifiers, although they must have unique network identifiers for each individual computer analogous to an MAC address. Such networks are within the scope of the present invention and are incorporated by reference when this application uses the term “MAC address”.

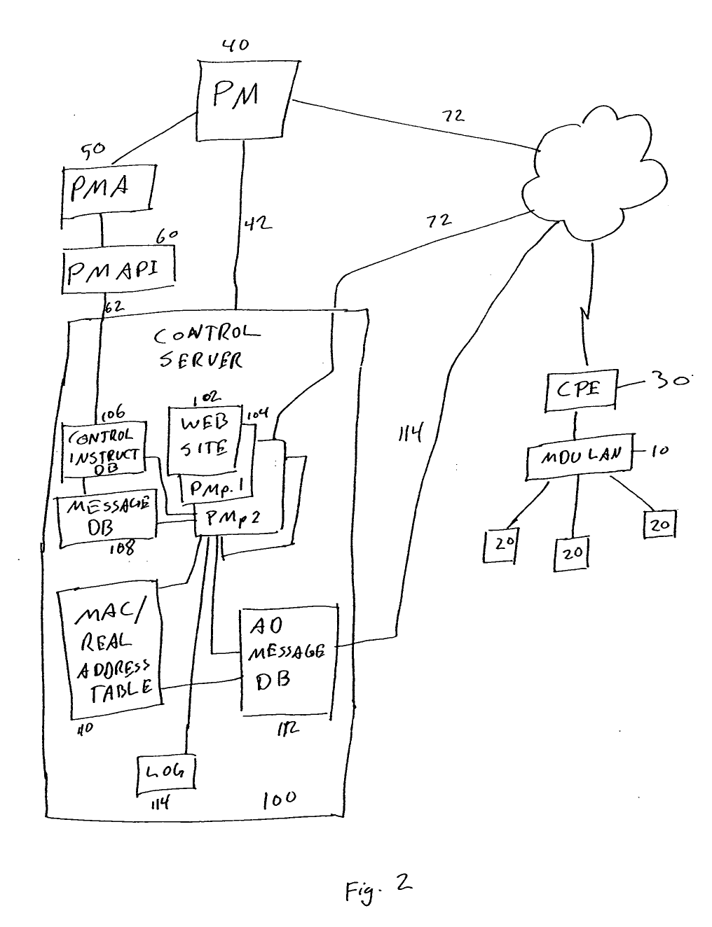

In FIG. 2 is depicted a block diagram of the MDU LAN along with further elements of the present invention. In addition to the MDU LAN components, FIG. 2 also depicts a property manager 40. Property managers frequently have property management applications in the form of software 50 which help track a variety of useful management variables such as repairs needed, rent due, occupants' data such as name and the like. Also depicted is a property management software application interface 60. Application specific interfaces 60 may be specifically dedicated to a particular property management application 50.

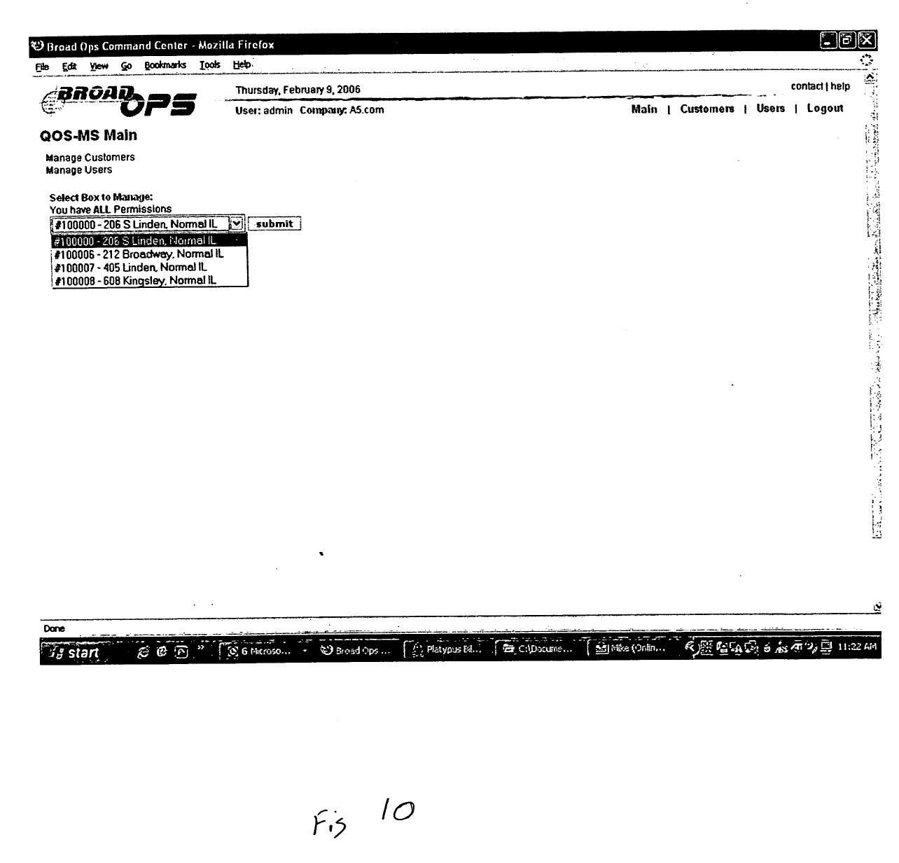

Also depicted in FIG. 2 is the control server of the present invention 100. The control server 100 maintains a website 102 and on that website are a plurality of property managers' secure pages 104. Via property management access through the internet or other WAN 72 each subscribing property manager 40 may access a page secured by a private user identification and password. Through that connection with the website 102 and control server 100 the property manager 40 may execute the controls over internet use at individual computers 20 according to the processes of the present invention. A single property manager 40 may be responsible for a single apartment complex and its MDU LAN 10 or multiple MDU LANs 10. Secured pages 104 may be configured in a single page including all the MDU LANs 10 managed by that property manager 40 or it may be configured for separate pages for each property or complex. FIG. 10 is a sample display of a property manager's secure page. On it is displayed a field with a drop down menu, the drop down menu having a list of the various MDUs for which that property manager is responsible. Using the drop down menu, the property manager may select one or more MDUs at which to execute further operations described below.

Each MDU LAN may be any of a wide variety of physical real world organizations, including without limitation apartment complexes in a single building, apartment complexes in multiple buildings, hospitals, hotels, nursing homes, dormitories, camps, businesses, corporations, bureaucracies or the like.

Control server 100 is at all times accessible by a control server maintenance personnel. Accordingly, property managers 40 who choose to do so, may manually convey instructions or requests to a control server via the manual route 42. Manual route 42 may include physically visiting field server maintenance personnel or contacting them by telephone or other means.

Finally, the property manager application interface 60 may connect 62 with the control server 100 and each of the components within it that are accessible to property manager control as described throughout herein.

At all times the control server 100 will maintain a control instruction database 106. The control server 100 will also maintain a message database 108. The control server will also maintain a table associating a MAC address for each individual computer 20 with real world identifying information for that user obtained by registration. This information will include at least a name for each user registered to that MAC address. Such users would most likely include the tenant in the apartment having the access interface for that individual computer 20. Accordingly, registration would identify that tenant, and may thereafter be populated with further information regarding that tenant obtained through the rental agreement, including street addresses and apartment numbers. Optionally, and without departing from the scope of the present invention, guests may log on from that particular physical location, as for example with their laptop. In such case, an initial use from a MAC address not previously registered will present a registration message and page to the new user and allow internet access only after the registration fields are properly filled in. Registration fields are configurable by the property manager 40.

The control server 100 also maintains a messaging database 112 designed to be accessible, under property manager control, to third parties. One means of access would be via the internet 114. These messages may include advertisements, among other things.

The control server 100 will also maintain a usage log 114 recording certain historical events for each individual computer 20 such as message receipt acknowledgements, as is more fully described below.

As can be seen, the property manager 40 through any access means 42, 62, or 72, has access to control the control instruction database 106, the message database 108, and the outside message database 112. The property manager 40 may also through any access means access log 114 to review aspects of the usage history for each individual computer 20.

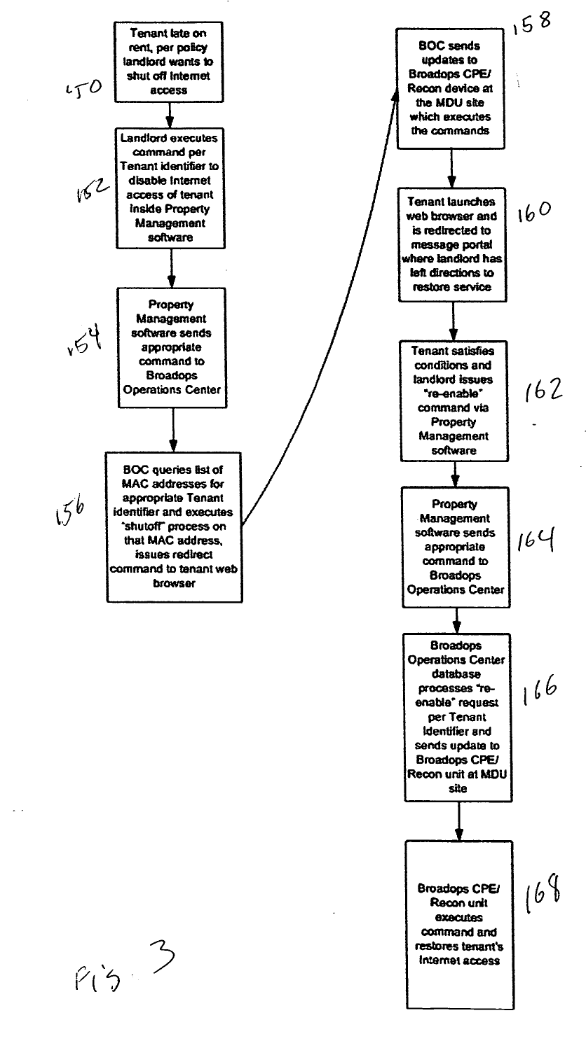

FIG. 3 is a flowchart depicting how a control instruction database 106 is used. One novel aspect of the present invention is that property managers may electronically control their tenant's internet access in order to positively influence the tenant's behaviour. The clearest example of using this control would be to encourage timely payment of rent. Other real world control issues may include compliance with the apartment complex rules, response to complaints or mandatory acknowledgements of certain messages as described below.

In FIG. 3, a flowchart depicting exercise of control in response to delinquent rent payment, a property manager 40 first determines that rent is delinquent 150. Through any of the access means described above, the landlord executes his command by a tenant identifier to turn off that particular tenant's internet access 152. The tenant identifier may simply be a name, or, as is used by many property managers with common property management application software 50, may be a unique number assigned to that tenant. In the embodiment depicted in FIG. 3, a property management software API 60 transmits the turn off command to the control server 100 at step 154. The control server 100 accesses the MAC/real address table 110 at step 156 and returns a computer MAC address for the tenant in question.

The turn off instruction is recorded in the control instruction database 106 and a signal is sent 158 to the CPE 30 to tag the individual computer 20 identified by its MAC address. When that particular tenant next attempts to launch his web browser, the CPE 30 will not connect that web browser but redirect the user to a message portal 160 where the user may read the landlord's message explaining the denial of access and providing instructions for how to remove his denial, i.e., how to pay his rent. The tenant presumably will next pay his rent and notify the property manager 40 in so doing. In response, the property manager through any means hereinbefore described, will communicate to the control server 100 a reenable command 162 be stored in a control instruction database 106 at step 164. Control server 100 then transmits this status to the CPE 30 for execution at step 166. CPE 30 thereafter reenables internet access for that individual computer 20 at step 168.

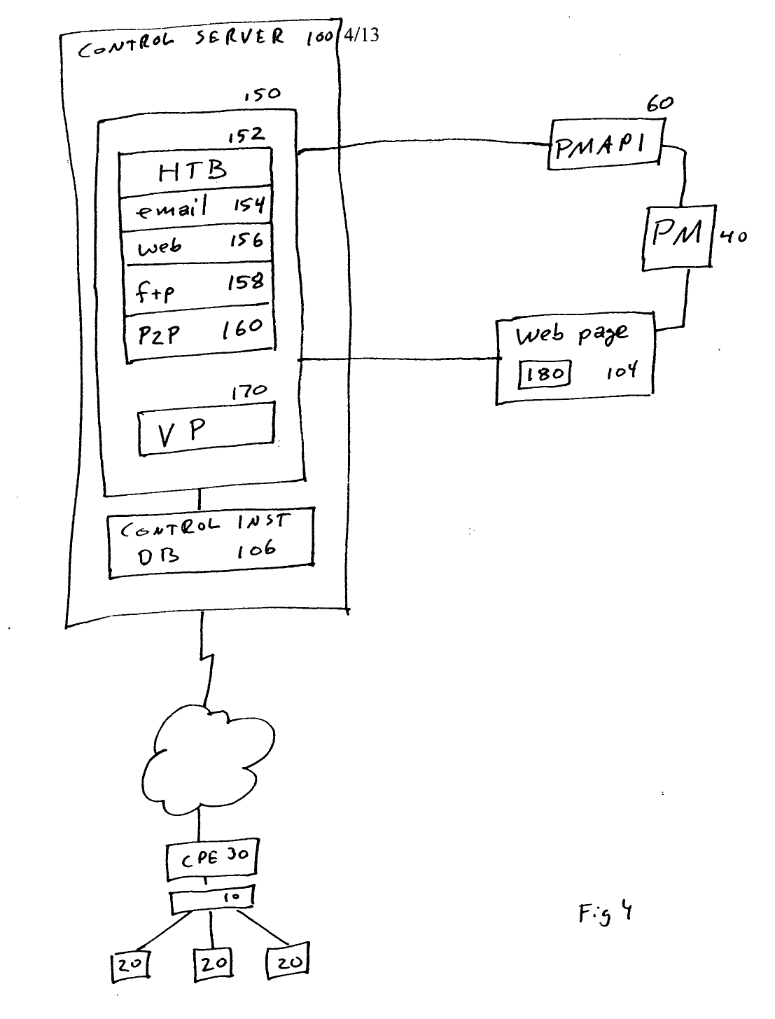

In addition to providing property managers control of internet or other network usage in response to real world behaviour, a property manager can also direct control of internet usage and access in response to a tenant's virtual behaviour; that is the nature and extent of the tenant's internet usage. FIG. 4 is a block diagram showing the usage module of the present invention. A usage module is associated with the control instruction database 106 and within the control server 100. The usage module includes a usage control application. In the depicted embodiment, a usage control application called hierarchical token buckets (HTB) is used. The HTB controller 152 prioritizes different characteristics of internet usage. Internet traffic is comprised of packets that HTB classifies by character according to a packet identifier data found in header bytes of each packet, according to known TCP/IP protocols. A typical configuration for HTB 152 would be a top category for email 154, a subordinate category for website access viewing 156, a further subordinated category for FTP file transfer 158 and a least desirable category for usage to be discouraged, such as peer to peer file sharing 160. Usage controllers such as HTB 152 allocate according to these configurable priorities a first and broadest amount of bandwidth for a LAN's access to a WAN such as the internet according to these preferences. Thus, broad bandwidth is maintained for email and, a smaller amount for website viewing access, a still smaller amount for FTB file transfer and a remainder for discouraged uses such as peer to peer file swapping. The control may allocate available bandwidth to preferred usages first, with unused bandwidth thereafter given to subordinate usages, provided that the bandwidth is not then being utilized by a preferred category of use. Bandwidth management applications, also known as bandwidth “throttles” or bandwidth “shapers” may also be configured to change priorities according to the time of day. Bandwidth may also be throttled or shaped in this hierarchical fashion in real time response to an operator's control.

A novel aspect of the present invention is to provide such control to a property manager. Hence, a property management application API 60 or, alternatively, a property management web page 104 is in operative communication with the usage module 150 and the bandwidth throttle 152 within it. Either on the web page 104 or in his property management application 60, a property manager may designate volumes of bandwidth for preferred and subordinate uses, change those volumes of use according to time of day, reorder the priorities, requantify the amount of bandwidth allocated to each category and the like. Moreover, through the control instruction database's association with the MAC/real address database 110, traffic may be controlled in particular for an individual tenant or other user at that apartment. For example, a particular user known to historically engage in peer to peer file sharing, thereby clogging bandwidth available on the network for use by other tenants in preferred categories, may have his individual computer 20 throttled down to zero in the disapproved peer to peer category by a property manager through accessing his web page 104 or property management application 60. This control may be in the form of a standing order or as a real time response to detected disapproved usage. It is within the scope of the present invention to thusly enable a property manager to custom tailor usage categories that are encouraged and discouraged in association with various markets for economic facts also associated with that particular MDU LAN. For example a lower or a higher rent or a more or less attractive neighborhood in which the physical building is located may be balanced with a bandwidth management package that is more or less desirable to target tenants.

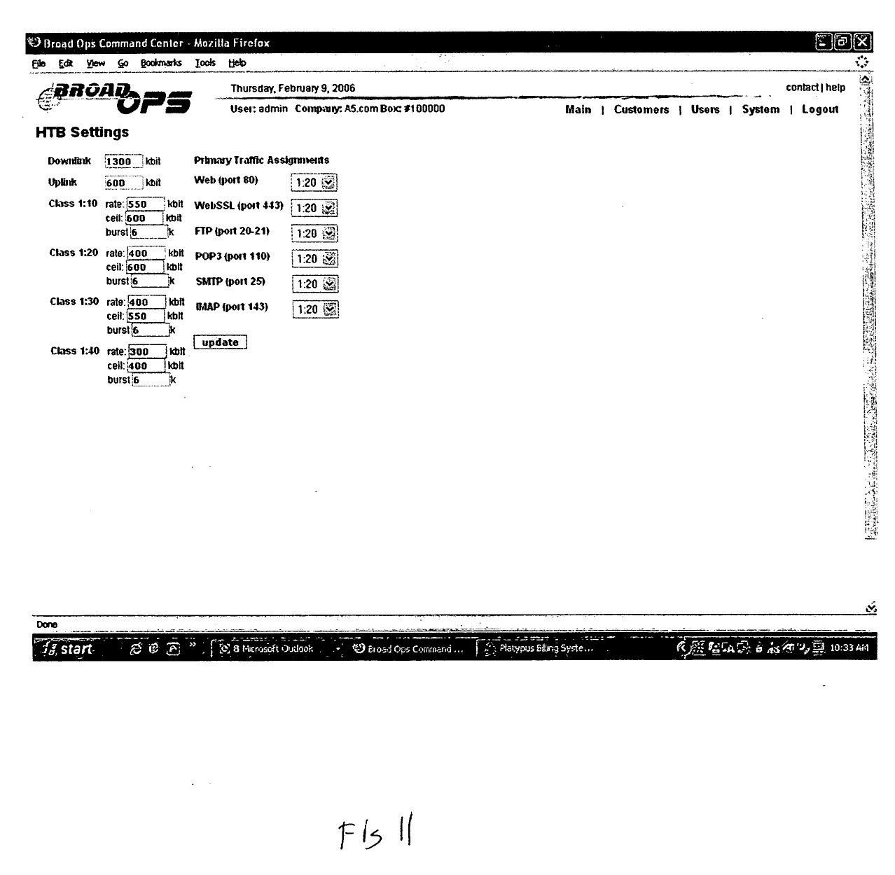

FIG. 11 depicts a property manager's secure web page 104 on which is displayed a variety of fields to use for usage control and bandwidth shaping. As can be seen in FIG. 11, downlink and uplink speeds may be entered in fields and primary traffic assignments such as described above may be entered in the fields provided. Having assigned various class ranks (e.g., class 1: 10; class 1: 20) separate fields are displayed for each class for the rate, a ceiling and a burst level. The property manager may access his secure page and enter appropriate rates for each class of usage.

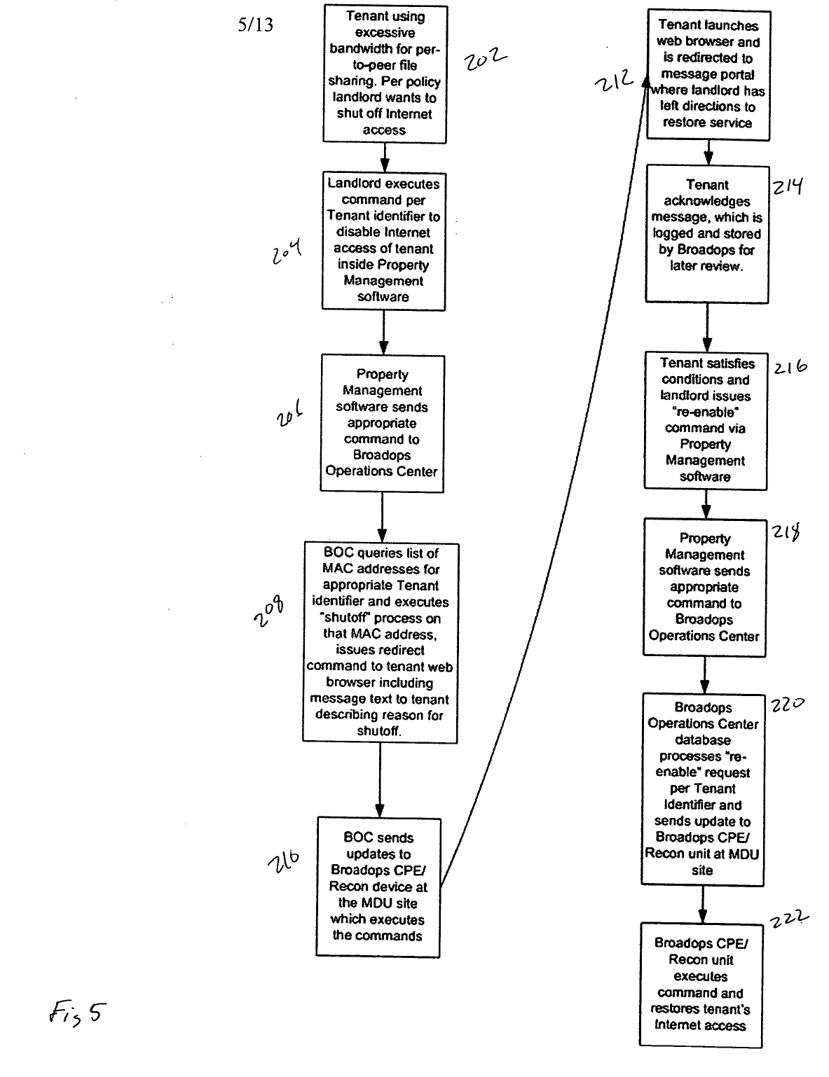

FIG. 5 is a flowchart depicting internet access shutoff for a tenant violation of a policy established by a property manager, such as an excessive volume of peer to peer file sharing. The process begins with a tenant using excessive bandwidth for peer to peer file sharing 202. The property manager commands internet access be disabled 204. Step 204 associates a tenant's disfavored use identified by MAC address with a tenant identifier or real world address from table 110. Step 204 may be initiated by a human property manager in response to notice of the disfavored use. The property manager may use any of the access means to the control server described herein. Alternatively, a shutoff command may be stored in association with the HTB processor in order to execute command step 204 automatically in response to detection of disfavored use. The shutoff command is transmitted to the control server at step 206. At step 208, the control server accesses the MAC address tenant identifier table 110 and uses it to associate the internet access shutoff command with that particular user's MAC address. At step 210 the control server forwards the properly addressed shutoff command to the CPE 30. At step 112, either at a next internet access by the targeted user, or by a next file share action, or immediately during current internet access, further access to the internet is denied. Optionally, a message is displayed to the user by the CPE 30. The message from the message database 108 explains to the user that the shutoff is for the disfavored use and instructs the user how to reestablish internet access, i.e., by curtailing the disfavored use. The message optionally includes an acknowledgement. At step 214 the tenant acknowledges receipt and understanding of the message and that acknowledgement is logged and stored. At step 216 the tenant satisfies the conditions for reestablishing internet access by curtailing the disfavored use. In response, the control server either automatically or in response to a property manager command, removes the access shutoff status. At step 218 is depicted execution of access shutoff removal via property management software and the API putting that property management software in operative communication with the control server. At step 220 the property manager's reenable command is executed by the control server, again associating the tenant identifier and/or real address with the MAC address and forwards the reenablement order to the CPE 30. Finally, the CPE restores the tenant's internet access 222.

Also within the usage module 150 is a virus protection or virus detection application 170. These applications are known to work in a variety of manners, most notably by detecting increased traffic by usage volume, as when a virus or worm infects a particular individual computer 20 and from it seeks to overload systems by sending out multiple emails or the like. It is within the scope of the present invention that configurable parameters of such virus protection may also be controlled by a property manager, although in practical reality such protection by management would not likely be changed frequently. As with the bandwidth shaper 152, the virus protection module 170 may be configured to automatically turn off an individual computer 20 if a virus is detected to be spreading from it. Individual computer turnoffs directed either from the bandwidth shaper 152 or virus protection application 170 are in operative communication through the control server 100 with the CPE 30 and thereby actuate the control of the MDU LAN.

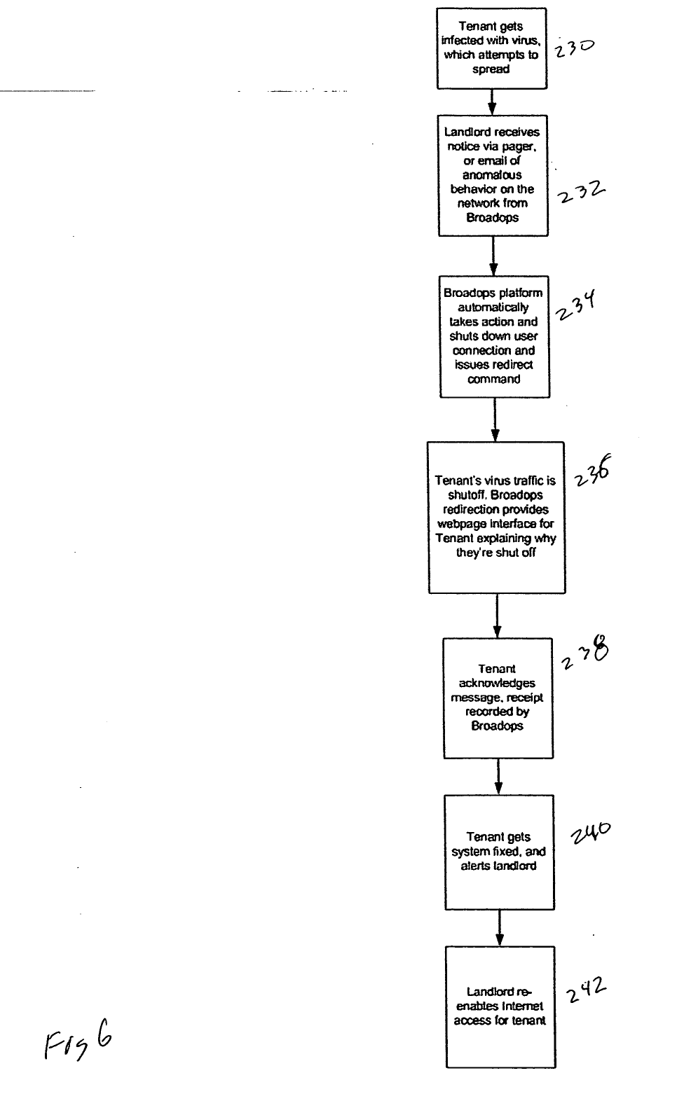

FIG. 6 is a flowchart depicting the shutoff process when a virus is detected. Initially, a virus infects a tenant's individual computer 20 and propagates from it, 230. Optionally, the virus protection or detection module 170 may notify the property manager of the virus detection. 232. Notice may be by any designated means including pager or email. The control server is preconfigured to respond to detection of a virus by shutting down the individual computer 20 identified by the MAC address. 234. Preferably, the control server also displays a message at the individual computer 20 explaining that the access shutoff is because of a virus propagating from that computer, 236. Optionally, this message also has an acknowledgement requirement and button 238. The tenant must then address the virus problem, as for example by loading a scrubber, virus protection software or otherwise 240. After the tenant has eliminated the problem, his next internet access will not propagate the virus, and therefore not trigger the automatic shutoff 242. Alternatively, the tenant may provide actual notice to the property manager that the virus has been eliminated, and the property manager can initiate an actual message to reestablish internet access to that tenant.

Also available to property manager 40 through any means of access described above is the message database 108. The present invention affords a scalable variety of opportunities for property managers to communicate with tenants. Addressing messages may be precisely controlled. The MAC/real address database 110 may be engaged for messages associated with real world facts. One example has already been given; a message to an individual user whose rent is delinquent. Similarly, groups may be identified and addressed according to real world circumstances. For example, units sharing a water heater may be informed that a plumber will repair the water heat at a given time. Similarly, all units may be advised of repairs such as parking lot repaving. Each of these may be entered in a message database 108 by the property manager 40 through the property management application API 60 or the web page 104.

Additionally, through operative communication with the control instruction database 106, a property manager may configure particular messages to be sent in association with virtual behaviour, that is usage of the WAN or internet. Accordingly, if a manager selects to warn a user of an individual computer 20 that continued usage will result in throttling or shut down, this message may be recorded and associated in the message database 108 with a send message signal to be activated upon receipt of a triggering event, such as detection of a disapproved usage, for example, peer to peer file sharing. The message database 108 may further associate a message with a timeout and a secondary control signal to shutoff access. Thus, if disapproved usage is detected, a warning message may be displayed at an individual computer 20 where the disapproved usage is occurring and remain there for a preconfigured amount of time, warning the user that shutoff is imminent, before actually ordering a shutoff of the internet access if the user has not complied in a reasonable, preconfigured time. Moreover, a secondary message explaining the action and indicating criteria for reestablishing usage may be displayed. Similarly, when the virus protection application 170 shuts off a particular individual computer 20 in response to detected virus, a message from the message database 108 may be displayed at that individual computer 20, in order that the user may understand why they were shut down.

The control server of the present invention also maintains a usage log 114 recording various aspects of usage by each individual computer 20. One novel aspect of the usage log of the present invention is recordation of acknowledgements. It is a peculiar feature of property management that certain notices are periodically given, for example, deadlines for obtaining a parking permit. When hard copies of notices are used, it is a frequent occurrence that a particular tenant will deny having received her notice. When notices are interposed between a particular user and his internet access, and can only be removed upon clicking an acknowledgement button on the message, the property manager can use the control server of the present invention to create a record that notices were acknowledged by each individual tenant in order to obviate this common tenant objection. Accordingly, the message database 108 may be put in operative communication with the usage log 114 in order to record such acknowledgements.

Another novel aspect of the present invention is achieved through the operative communication of the message database and the MAC/real address database 110 with a third party messaging database 112. Examples of third party messages include advertising. With review, approval, and if so desired, payment to the property manager, a third party may target messages such as advertising to individual apartments. Property managers, through the MAC/real address database 110, can associate an individual computer through its MAC address with an individual person, the tenant, at his exact street address. Thus, geographically targeted advertising may be made much more precise than the previously available technology, which was no more precise than a zip code, provided a geographic targeting advertiser works through the property manager equipped with the present invention. The present invention may further augment the flexibility of such a system by associating the third party messaging database 112 with a GPS geographic latitude and longitude database storing a table of the precise latitude and longitude of particular apartment and street addresses. Through such fine grained geo targeting of advertising, local businesses such as pizza delivery shops may advertise only on certain blocks and not others, may precisely define delivery areas and the like.

Third party messages would appear on a variety of messaging communications between the control server and the tenant's individual computer 20. For example, the default home page viewed by the user upon establishing internet access would have such advertising. Secondly, the previously described message service may also provide space for such advertising.

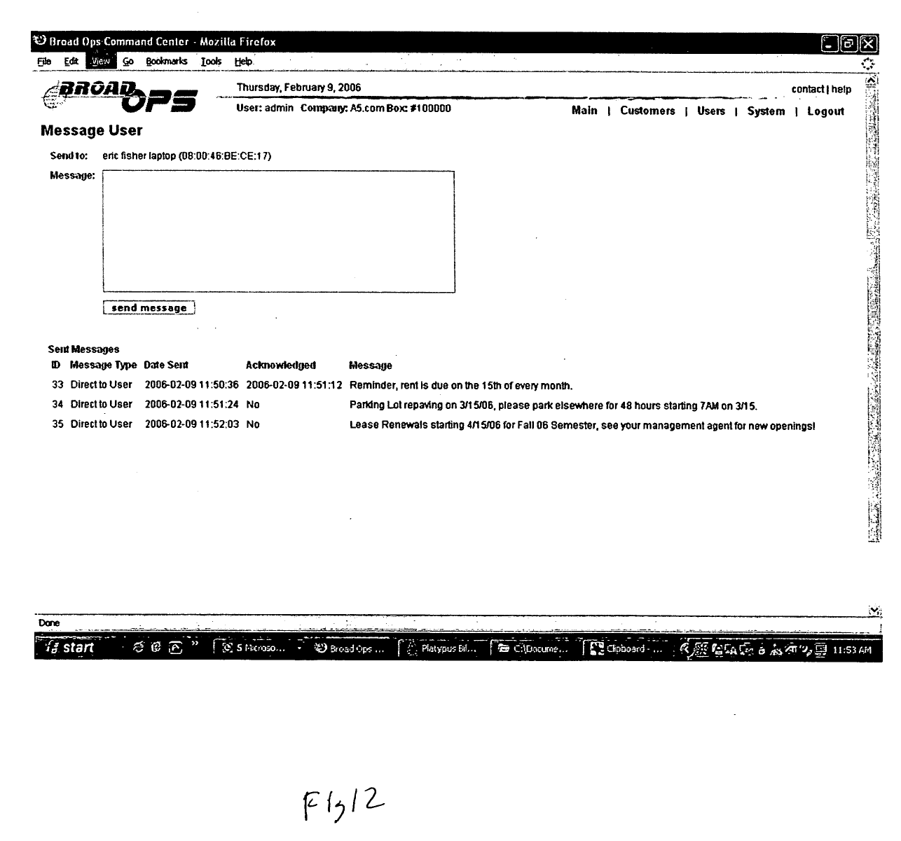

FIG. 12 depicts a property manager's secure web page with a message field. A property manager has access to the fields to send to, which may be filled in with an individual, as depicted, or, alternatively via a drop down menu in which subgroups, various selected individuals, or all tenants may be designated to receive the message. A second field, “message:” provides a space into which the actual message may be typed. Also beneath the message field is a display of the acknowledgement log.

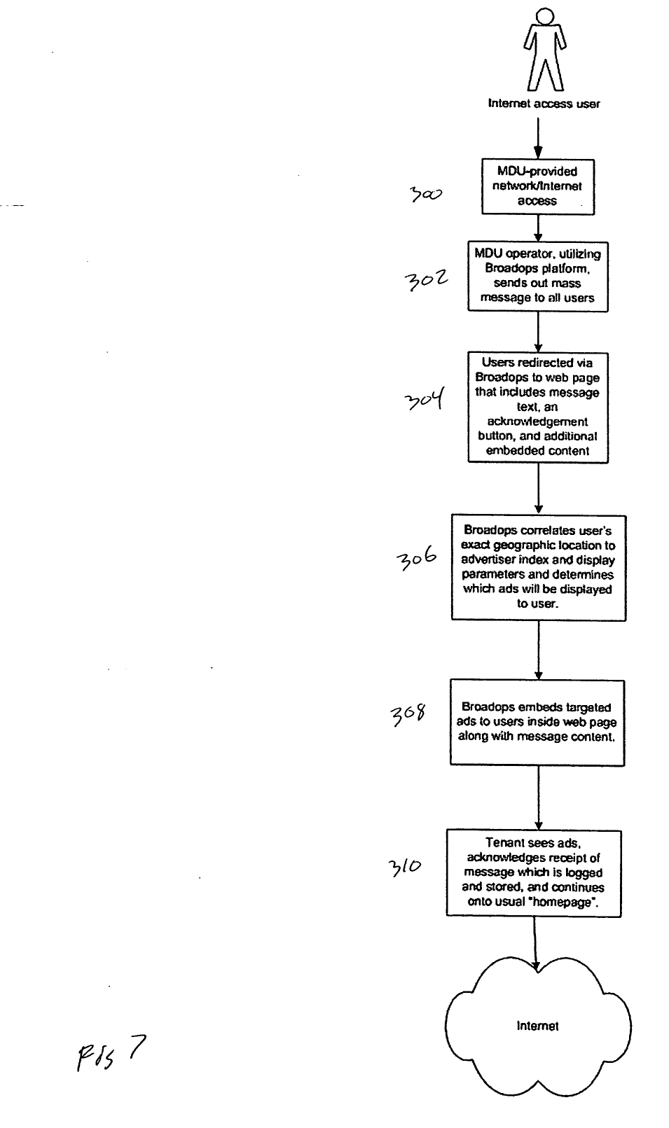

FIG. 7 is a flowchart depicting the steps for executing message targeting by a property manager in the MDU. First the internet access is provided 300. Next the property manager or other MDU operator sends out messages to all units or to a selected group of affected units 302. The message is called up from the message database 108, or is typed in by a property manager or operator into a field provided for custom messages. Addressing parameters, e.g., all users, a list of tenant identifiers, unit numbers or the like, are also filled in by the operator. The tenants at their individual computers 20 are redirected to the message text on their MDU webpage 304. The message includes an acknowledgement. The tenant or user proceeds to internet access and eliminates the message by pressing the message's acknowledgement button. Supplemental messages, such as advertising, may be displayed with the basic message. Thereafter, each individual tenant's geographical location is recalled from the MAC address/real address table 110, which is reviewed according to display parameters 306, which are entered by an operator on behalf of a client message provider, such as an advertiser who wants to advertise in some locations but not others. Those addresses selected by these display parameters are identified and their MAC address is correlated with the outgoing base message at step 306. The control server embeds the targeted messages such as advertisements with the base message at step 308. It should be noted that for these purposes, the base message may be merely pro forma or otherwise attenuated. That is, the base message may simply be greetings or another welcome display at an initial MDU page viewed by the user before proceeding to the user's normal home page or other internet use. Whether the base message is substantive or not, the tenant views it, may optionally acknowledge it, particularly if it is substantive, and continues on to his usual home page 210.

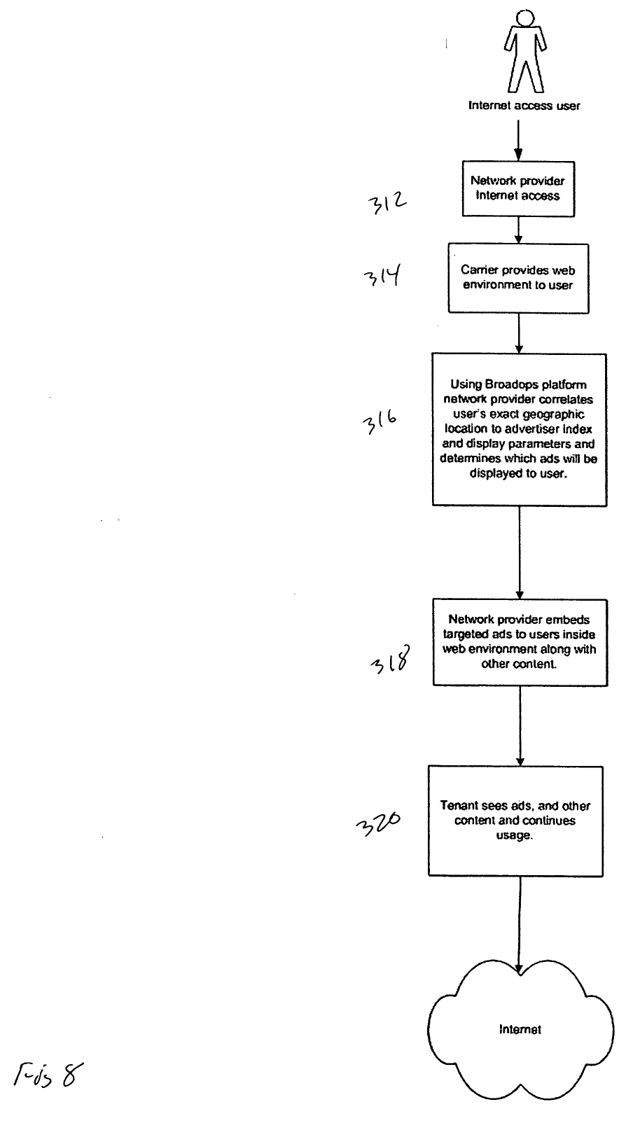

FIG. 8 is a flowchart depicting steps for message targeting without association of a supplemental message such as advertising with a base message, such as a notice from the property manager. As before, a network provider provides the tenant with internet access 312. A carrier provides web or internet environment to the user 314. Again, the control server allows correlation of the user's exact geographic location through use of the MAC address/real address table 110 and preconfigured display parameters entered by an operator and provided by a message source such as an advertiser. This process may select which of the CPEs and therefore which MDUs will receive the advertisement, at step 316. Alternatively, the process may select which of the tenants on the MAC address table 110 will receive the advertisement, at step 316. The network provider then embeds the targeted advertisements inside the web environment being viewed by the users 318. Finally, the message or advertising content is displayed to the tenant 320.

The control server may also provide an available link 410 to third party messengers and thereby link the database having a precise geographical information about an individual user with outside databases having usage associations recorded for an individual user, such as those known to be used currently by Google and other search engines. Accordingly, the control server may through the use of Boolean logic, associate any tenants in a particular property manager's control in a geographic area of interest to a third party messenger or advertiser with those tenants in that area having a particular usage characteristic, and thereby target ads to only those people having both characteristics combined; a particular usage history within a given geographical area. For example, a university may seek to notify persons known to have purchased tickets to an athletic event on campus and within a certain geographic area deemed to be within walking distance, that a free concession is offered to those who walk to the game, in order to lessen overcrowding of parking lots.

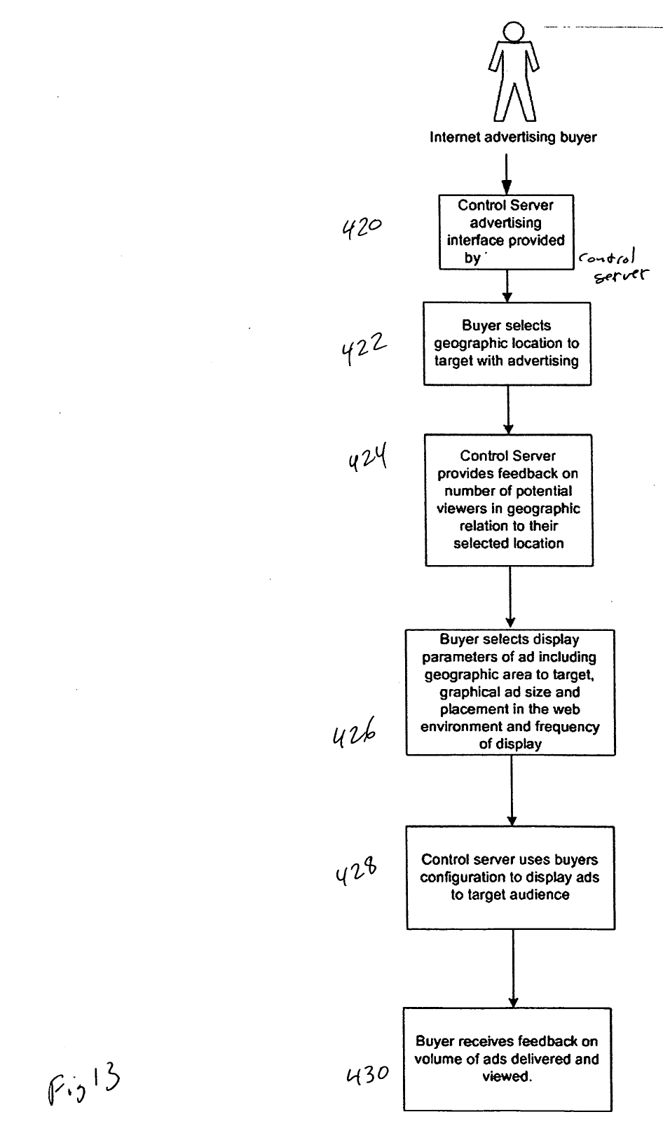

FIG. 13 is a flowchart depicting the steps for advertising or other messaging being entered into the system by the advertiser or other third party messenger. An interface is provided by the control server at 420. The access may be by web page, manually visiting the operator of the control server or through an API adapted to interface with graphic or other software used by the third party. The third party messenger or advertiser selects geographic locations to target from among the choices made available by the control server 422. The control server provides any of a variety of feedback displays or metrics to the third party messenger 424. These may include the number of persons in the MDU database fitting the geographic boundaries or characteristics submitted as a preference of the third party messenger. The third party messenger may adjust the geographical preferences until an acceptable reference is defined. Thereafter, the buyer or third party messenger selects display parameters 426. These may include an addition to the geographic area of the target, message size, message location, for example on a greeting home page of the tenant, on specific messages to tenants or otherwise. The frequency of display is also a selectable display parameter. Upon finalization of the display parameters, the control server enters these buyer configurations in association with the next cycle of access by and/or messaging to selected tenants 428. Optionally, the control server may record hits or click throughs in order to provide volume feedback to the third party message buyer 430.

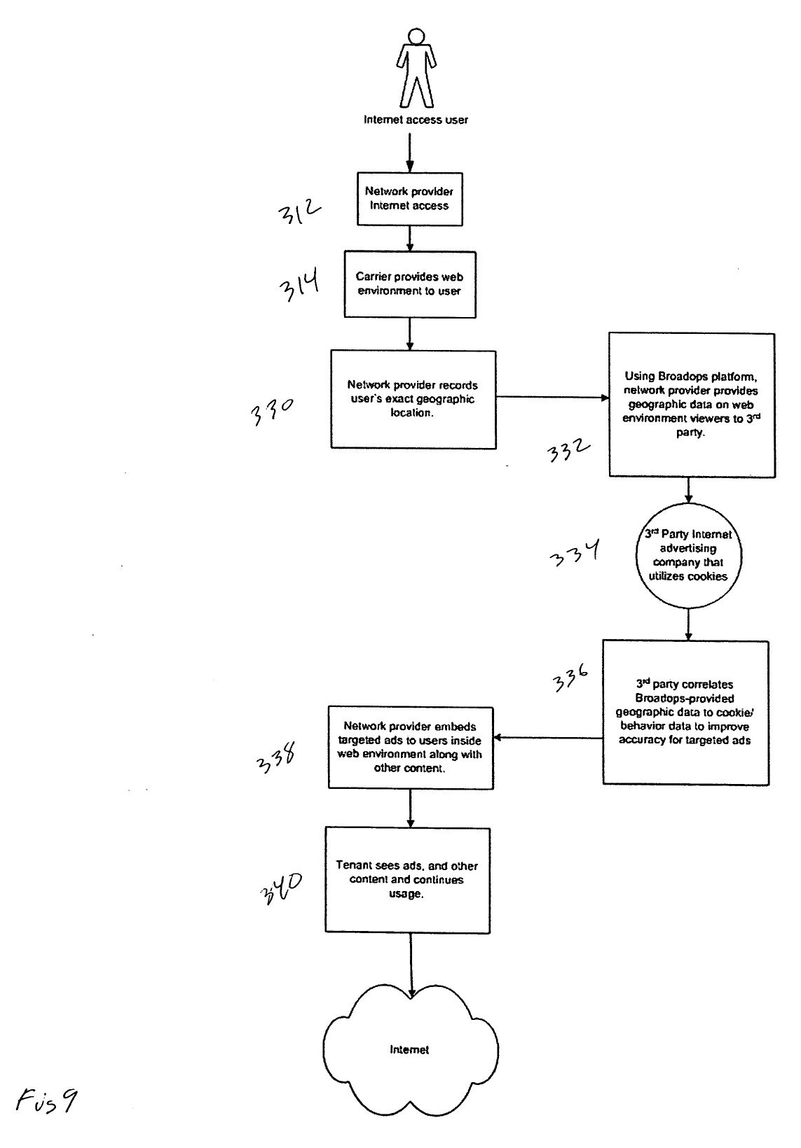

FIG. 9 is a flowchart depicting the steps for targeted advertising correlating geographical information provided by the present invention with third party database information. Any such other information may be the substance of a third party database. Such databases are commonly used currently to track individual internet viewer's usage data. That is, they record the content and particular pages the user is viewing and clicking upon. As depicted in FIG. 9, the network provides internet access before 312. The carrier provides a web environment to the user 314. Next, the network accesses the MAC address/real address database 110 in order to record an individual user's exact geographic location. It should be noted that it is within the scope of the present invention that the exact geographic location be designated as a street address or otherwise. Thus, it may also be designated as a precise latitude and longitude, as by Global Positioning Service (GPS) measurement, which may be loaded by the property manager. Next, the control server provides access to this geographic data to subscribing third parties 332. Such third parties 334 may be internet advertising companies. They may or may not use cookies, web site registrations, or other relevant databases. Next, the geographical data originating from the MAC address/real address table 110 may be correlated with other databases according to configurable parameters. These correlations may be simple Boolean operators. Thus, for example, correlation may be students at a local university from a first database AND persons living along designated streets, provided from the MAC address/real address table 110. Another example may be data retrieved from cookies or registrations, such as people who have viewed particular web pages AND living within a certain geographical area. As a third example, the third party database may be previous customers, as for example, at a pizza parlor, AND persons living on particular streets. Step 336 in the depicted embodiment may be executed by the third party. It is also within the scope of the present invention that the control server of the present invention may receive MAC addresses or other unique identifiers provided by a third party according to their own metrics of interest and that the correlation with the geographic data may be executed by the control server of the present invention. According to the results of correlation steps 336, the network provider embeds the targeted ads in the targeted user's web environment along with other content 338. The tenant then views the messages or advertisements 340.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A tenant LAN controller comprising:
an association of an MAC address with a geographic location in a first memory;
a router connecting a WAN to a plurality of individual computers;
a processor, said processor being configured to turn off an individual computer upon said individual computer being associated with a triggering event, said individual computer being identified by said association of a geographic location with an MAC address in said first memory;
said processor being further configured to throttle bandwidth according to instructions received via said WAN from a web page;
said processor being further configured to send messages to a particular MAC address according to said association of geographic locations with MAC addresses; and
said processor being further configured to log acknowledgements, said acknowledgements being stored in a second memory, and said acknowledgements being associated in said second memory with an MAC address.

2. The controller of claim 1 wherein said geographic location is a street address.

3. The controller of claim 1 wherein said trigger is delinquent rent.

4. The controller of claim 1 wherein said trigger is overuse of bandwidth.

5. The controller of claim 1 wherein said trigger is detected virus activity.

6. The controller of claim 1 wherein said trigger is peer to peer file sharing.

7. The controller of claim 1 wherein said plurality of individual computers is a LAN.

8. The controller of claim 1 wherein said first memory is at a computer remote to said LAN.

9. The controller of claim 1 wherein said web page is at a computer remote to said LAN.

10. The controller of claim 1 wherein said turn off configuration is received from an MDU API.
